(19) United States
(12) Patent Application Publication
(10) Pub. No.: US 2018/0312999 A1
(43) Pub. Date: Nov. 1, 2018

(54) Systems and Methods for In Silico Drug Discover

(71) Applicant: GEORGETOWN UNIVERSITY, Washington, DC (US)

(72) Inventors: Salim Shah, Vienna, VA (US); Qingliang Li, Gaithersburg, MD (US)

(73) Assignee: GEORGETOWN UNIVERSITY, Washington, DC (US)

(21) Appl. No.: 15/769,446

(22) PCT Filed: Oct. 19, 2016
(86) PCT No.: PCT/US16/57621

§ 371 Date: Apr. 19, 2018

Related U.S. Application Data
(60) Provisional application No. 62/244,023, filed on Oct. 20, 2015.

(51) Int. Cl. C40B 30/02

(52) U.S. Cl. CPC C40B 30/02

(57) ABSTRACT

Provided herein are methods of computer-assisted identification of a compound that binds to a target protein.

### CROSS REFERENCE TO RELATED APPLICATIONS

This application claims priority to and the benefit of U.S. Provisional Patent Application 62/244,023 filed Oct. 20, 2015, the contents of which are incorporated herein by reference in their entirety.

### BACKGROUND

Identifying compounds that bind to target proteins and modulate their activities is central to drug discovery. However, well-defined drug binding sites are often unavailable and undesirable off-target effects are prevalent. Therefore, current methods of identifying target protein conformations with available drug binding sites in order to identify compounds that selectively bind to a target protein are fraught with errors.

### SUMMARY

Provided herein are methods of computer-assisted identification of a compound that binds to a target protein. By combining molecular dynamics simulation with clustering algorithms, the methods provide physiologically relevant conformations of a target protein that are used to identify compounds that bind to the target protein. Optionally, the methods include determining if the compound has toxicity or an undesirable or desirable off-target effect(s).

Provided herein are in silico methods of identifying a compound that binds to a target protein. The methods comprise (a) receiving an estimated three-dimensional (3D) structure of a target protein, the 3D structure comprising a plurality of amino acids; (b) performing molecular dynamic simulations of the target protein to obtain a plurality of trajectories of the 3D structure, wherein each trajectory corresponds to a different set of positions for the plurality of amino acids; (c) obtaining a plurality of snapshots from each trajectory; and (d) clustering the plurality of snapshots using DBSCAN. Clustering comprises for a plurality of pairs of snapshots (i) computing a similarity metric between the pair of snapshots, the similarity metric including differences in positions of the plurality of amino acids between the two snapshots; (ii) clustering the snapshots using the similarity metrics to obtain a plurality of snapshot clusters; (iii) identifying a set of the snapshot clusters from one or more trajectories as corresponding to conformations of the target protein, each conformation corresponding to a particular set of positions for the plurality of amino acids; and (iv) determining, for each of the conformations, whether a compound binds to the conformation of the target protein.

### DESCRIPTION OF FIGURES

FIG. 1 provides a system diagram for identifying a compound that binds a target protein. Processes illustrated in the system include target characterization, which includes homology modeling of a target protein with an unknown structure, generation of protein conformations using molecular dynamics simulations (MD or MD simulation) and clustering, docking, identification of compounds that bind to the target protein, experimental testing, safety testing and toxicity testing. Many of the processes in the system, including homology modeling, MD simulations, clustering and docking can be performed in silico, for example, on a computer or a supercomputer.

FIG. 2 depicts example schematics of data structures utilized for identification of a compound that binds a target protein.

FIG. 3 shows the results of docking experiments. MD simulation and homology modeling produced a large collection of snapshots. To select the best snapshot (conformation) for ligand binding, the known active chemical compounds were used as probes to dock against all the snapshots from MD simulation and homology modeling. The snapshot with the best docking score (more negative indicative of a better docking score) was selected as the conformation for further lead optimization. The results of docking active compounds against representative homology models of LRRK2 are shown.

FIG. 4 shows docking results against selected homology models of LRRK2 for an active vs. an inactive compound. These results validated the strategy for distinguishing an inactive chemical compound from an active compound. These results also explain the structural features that make the compounds active vs. inactive.

### DETAILED DESCRIPTION

Provided herein are in silico methods of identifying a compound that binds to a target protein. The methods comprise (a) receiving an estimated three-dimensional (3D) structure of a target protein, the 3D structure comprising a plurality of amino acids; (b) performing molecular dynamic simulations of the target protein to obtain a plurality of trajectories of the 3D structure, wherein each trajectory corresponds to a different set of positions for the plurality of amino acids; (c) obtaining a plurality of snapshots from each trajectory; and (d) clustering the plurality of snapshots using DBSCAN. Clustering comprises for a plurality of pairs of snapshots (i) computing a similarity metric between the pair of snapshots, the similarity metric including differences in positions of the plurality of amino acids between the two snapshots; (ii) clustering the snapshots using the similarity metrics to obtain a plurality of snapshot clusters; (iii) identifying a set of the snapshot clusters from one or more trajectories as corresponding to conformations of the target protein, each conformation corresponding to a particular set of positions for the plurality of amino acids; and (iv) determining, for each of the conformations, whether a compound binds to the conformation of the target protein.

As used herein, MD simulation refers to computer-based molecular simulation methods in which the time evolution of a set of interacting atoms, groups of atoms or molecules, including macromolecules, is followed by integrating their equations of motion. The atoms or molecules are allowed to interact for a period of time, giving a view of the motion of the atoms or molecules. MD simulations can be physics based simulations, energy based simulations or combinations thereof. Typically, the trajectories of atoms and molecules are determined by numerically solving the Newton's equations of motion for a system of interacting particles, where forces between the particles and potential energy are defined by molecular mechanics force fields. However, MD simulations incorporating principles of quantum mechanics and hybrid classical-quantum mechanics simulations are also available and are contemplated herein.

Energy based molecular dynamics simulation can calculate forces exerted by and among the members of a simulated system (e.g., atoms, groups of atoms, or molecules), including, but not limited to, the function of the distance, properties (e.g., charge, polarizability, etc.), and relation (e.g., bound or unbound) of the members of a system. Thus, MD simulations can comprise steps of simulating a conformational change of all or part of a starting conformation of a molecule towards a different conformation of the molecule. Such changes can arise from changes to the positions of atoms or groups of atoms from their respective positions in a starting molecular structure of a molecule to their respective positions at the end of the simulation. MD simulation can also be used to simulate a conformational change of all or part of a starting conformation of a complex, for example a complex between a target protein and a compound, towards a different conformation of the complex. Therefore, it is understood that, MD simulation can be performed on the 3D structure of a target protein in the presence or absence of a compound that binds the target protein.

Molecular simulations can be used to monitor time-dependent processes of molecules, in order to study their structural, dynamic, and thermodynamic properties by solving the equation of motion, e.g., the chemical bonds within proteins may be allowed to flex, rotate, bend, or vibrate as allowed by the laws of chemistry and physics. This equation of motion provides information about the time dependence and magnitude of fluctuations in both positions and velocities of the given molecule. Interactions such as electrostatic forces, hydrophobic forces, van der Waals interactions, interactions with solvent and others may also be modeled in MD simulations.

Examples of the changes that can be simulated with the MD simulation algorithms described herein include, but are not limited to, simulating conformation changes of one or more side-chain dihedral angles in a structure, or changes of the translational and rotational degrees of freedom of an object in a given space. The translational and rotational degrees of freedom of an object can be expressed in terms of the object's position and orientation in a space.

MD simulation methods suitable for use with the methods described herein can further comprise calculation of restraints on conformational flexibility, including, for example, dihedral restraints, position restraints including linear position restraints and/or harmonic position restraints, and conformational restraints, simultaneously or sequentially in any suitable order. Restraints that can be used in connection with the molecular dynamics simulations described herein include restrictions on the position of a member (e.g., an atom, group of atoms, or molecule) of a molecular dynamics simulation as well as restraining one or more positions of a member as an absolute coordinate (value or range), as a function of a coordinate system, or as a coordinate (value or range) relative to one or more other members of the system.

MD simulations can also comprise pairwise interaction calculations for particles. Such pairwise interactions can be calculated using a number of different methods, including, but not limited to, mid-point and neutral-territory methods (Bowers et al., J. Chem. Phys 2006, 24, 184109; Bowers et al., J. Phys.: Conf. Series 2005, 16, 300-304; M. Snir, Theor. Comput. Syst., 37: 295-318, 2004; Plimpton and Hendrickson, J. Comput. Chem., 17(3): 326-337, 1996; see also U.S. Pat. No. 7,707,016 and U.S. Pat. No. 8,126,956). The pairwise interactions can be calculated by computing interactions between all pairs of particles, or alternatively by computing interactions only between pairs separated by less than a predefined interaction radius (near interactions). Thus, simulation can be performed by computing only near interactions or both near and distant interactions (i.e., interactions that occur over distances greater than the predefined interaction radius). Serial or parallel processing methods can be used to compute any of the molecular dynamics simulations used in connection with the methods described herein. Many methods for parallel processing are known in the art, including atom, force, and spatial decomposition methods. See, for example, Heffelfinger, “Parallel atomistic simulations,” Computer Physics Communications, vol. 128. pp. 219-237 (2000), and Plimpton, “Fast Parallel Algorithms for Short Range Molecular Dynamics,” Journal of Computational Physics, vol. 117. pp. 1-19 (March 1995).

MD simulations can also employ spatial decomposition algorithms in connection with the methods described herein. For example, spatial decomposition can be used to consider pairs of nearby particles as opposed to considering all pairs in a system. In another example, a combination of spatial and force decomposition methods can be used in connection with the methods described herein. See, for example, Snir, Theory Comput. Systems 37, 295-318, 2004 and Shaw, J Comput. Chem. 2005 October; 26(13):1318-28. The type of molecular dynamics simulation used in connection with the methods described herein can depend on a number of factors, including the physical system to be simulated (e.g., system dimensions, interaction radius) and the hardware available for the simulation.

MD simulation methods suitable for use with the methods described herein also include Ewald summation methods (Ewald, P. Ann. Phys. 1921, 369, 253-287). These methods generally employ calculations that sum interaction energies in real space with an equivalent summation in Fourier space to compute interaction energies of periodic systems (e.g., crystals) and can be used to compute long range electrostatic force terms in molecular dynamics simulations. Derivations of traditional Ewald methods, such as the smoothed particle-mesh Ewald summation (SPME) and Gaussian split Ewald method (GSE) are also suitable for use with the methods described herein (Essman et al., J. Chem. Phys. 1995, 19, 8577-8593; Shan et al., J. Chem. Phys. 2005, 5, 54101-54113; see also U.S. Pat. No. 7,526,415).

Other MD simulation software packages or computer hardware that can be used in connection with the methods of the invention include, but are not limited to, Desmond (Bowers et al., Proceedings of Super Computing 2006, Tampa, US, 11-17 Nov. 2006), NAMD (Phillips et al., J. Comp. Chem. 2005, 26, 1781-1802), Gromacs4 (Hess et al., J. Chem. Theor. and Comp. 2008, 4), Charmm (Brooks et al., J. Comp. Chem. 1983. 4 (2): 187-217), Amber (Pearlman et al., Comp. Phys. Commun., 1995, 91, 1-41), and molecular dynamics hardware suitable for use with MD simulation software packages. Other molecular dynamics hardware that can be used include a special purpose supercomputer such as, but not limited to, the Anton supercomputer (see U.S. Application Publication No. 20130091341) or the MD-GRAPE supercomputer (Komeiji et al., J. Comp. Chem., 1997, 18, 1546-1563). For example, GROMACS or any other MD simulation software can be run on Linux workstations and/or Linux clusters.

Optionally, MD simulation methodologies suitable for use with the methods described herein can comprise elements of semi-rigid-body docking algorithms. Specific molecular dynamics methods suitable for use with the methods described herein include, but are not limited to, RosettaDock (Gray et al. 2003 J Mol Biol 331(1): 281-99)), as well as those described in J M Haile, 1997, “Molecular Dynamics Simulation: Elementary Methods,” Wiley-Interscience, 1^{st} ed., ISBN: 047118439X; and D C Rapaport, 2004, The Art of Molecular Dynamics Simulation, Cambridge University Press; 2^{nd} ed., ISBN: 0521825687. Other molecular dynamics methods suitable for use with the methods described herein include, but are not limited to, GROMACS (see, for example, Lindahl et al. 2001. Journal of Molecular Modeling 7: 306-317; Van Der Spoel et al. 2005. J Comput Chem 26: 1701-18; and Hess et al. 2008. J Chem Theory Comput 4: 435); GROMOS (see, for example, van Gunsteren et al., 1996, Biomolecular Simulation: The GROMOS96 Manual and User Guide, Vdf Hochschulverlag AG an der ETH Zurich, Zurich, Switzerland, pp. 1-1042); AMBER (see, for example, Case et al. 2005. J Computat Chem 26: 1668-1688; and Case et al., 2008, AMBER 10, University of California, San Francisco); and CHARMM (see, for example, Brooks et al. 1983. J Comp Chem 4: 187-217; and MacKerell et al., 1998, CHARMM: The Energy Function and Its Parameterization with an Overview of the Program”, in The Encyclopedia of Computational Chemistry, 1^{st} ed., John Wiley & Sons: Chichester, pp. 271-277).

In the methods set forth herein, MD simulation produces a plurality of trajectories of atomic positions (and optionally velocities and energies) as a function of time. Timescales that can be used for molecular dynamics simulations include 1 ns or less, or from about 1 to about 100000 ns. For example, simulations of about 1 ns, 5 ns, 10 ns, 20 ns, 30 ns, 40 ns, 50 ns, 60 ns, 70 ns, 80 ns, 90 ns, 100 ns, 200 ns, 300 ns, 400 ns, 500 ns, 600 ns, 700 ns, 800 ns, 900 ns, 1000 ns, 5000 ns, 10000 ns, 20000 ns, 30000 ns, 40000 ns, 50000 ns, 60000 ns, 70000 ns, 80000 ns, 90000 ns, 100000 ns or any amount of time in between these times can be performed. In another example, simulations of about 1 microsecond to about 10 microseconds can be performed. Simulations of greater than 1000 ns can also be performed. MD simulation can be used to model the dynamics of a system, for example, a target protein, comprising at least 1,000 atoms, at least 5,000 atoms, at least 10,000 atoms, at least 20,000 atoms, or 50,000 or more atoms. Examples of target proteins include, but are not limited to, enzymes, structural proteins, signaling proteins, receptors, regulatory proteins, transport proteins, sensory proteins, motor proteins, defense proteins and storage proteins.

In the methods provided herein, a plurality of snapshots (coordinates and velocities at a specific time during the trajectory) are obtained from each trajectory produced by the MD simulation. Each trajectory corresponds to a different set of positions for the plurality of amino acids in the target protein. The snapshots are taken at equal time intervals, or sampling intervals. For example, snapshots were extracted from each of the MD trajectories at an interval of 2 ps and saved as conformers. About 500 conformational snapshots were identified. In the methods provided herein, once the snapshots are obtained, a clustering algorithm is used to group the snapshots into clusters. As used herein, a clustering algorithm refers to computational approaches for grouping snapshots of similar conformations in the trajectory into clusters. Clustering algorithms are known in the art. (See, Shao et al. Clustering Molecular Dynamics Trajectories: 1. Characterizing the Performance of Different Clustering Algorithms, J. Chem. Theory Comput. 3: 2312-2334 (2007); Ester et al. A density-based algorithm for discovering clusters in large spatial datasets with noise, Proceeding of the Second International Conference on Knowledge Discovery and Data Mining pp. 226-231 (1996) for the use of DBSCAN). In the methods set forth herein, clustering pluralities of snapshots comprises, for a plurality of pairs of snapshots, computing a similarity metric between the pair of snapshots, the similarity metric including differences in positions of the plurality of amino acids between the two snapshots and clustering the snapshots using the similarity metrics to obtain a plurality of snapshot clusters. Similarity metrics that use parameters, for example, root mean squared deviation (RMSD), free energy change and binding site similarity, to name a few, can be used to group or cluster similar conformations of the target protein.

DBSCAN was adapted for MD snapshot clustering. The programming code set forth below is an example of a script, as coded in Python, for the use of DBSCAN in MD snapshot clustering.

import MDAnalysis from MDAnalysis.analysis.rms
import rmsd from MDAnalysis.analysis.distances
import self_distance_array, distance_array
import numpy from sklearn.cluster import DBSCAN
import logging
class MDClusterError(Exception):

“““Base class for all errors in mdcluster
”””
pass

class Snapshots(object):

logger = logging.getLogger(_{——}name_{——})
def _{——}init_{——}(self, top, traj, select=‘all’, step=1, *args, **kwargs):

self.select_ = select
self.step_ = step
try:

self.universe = MDAnalysis.Universe(top, traj, *args, **kwargs)

except Exception as e:

raise MDClusterError(“Failed to construct from trajectory.\n Error:{ }”.format(e))

try:

self.atom_group = self.universe.selectAtoms(self.select_)

except Exception as e:

raise MDClusterError(“Failed to complete selection.\n Errors: { }.”.format(e))

@classmethod
def from_pdb_file(cls):

pass

@classmethod
def from_folder(cls):

pass

@property
def count(self):

return len(self.universe.trajectory)

def _{——}getitem_{——}(self, index):

mol = self.universe.selectAtoms(‘protein’)
try:

snapshots = self.universe.trajectory._{——}getitem_{——}(index)

except IndexError as e:

raise MDClusterError(“Outside of the trajectory boundary { }”.format(e))

if isinstance(index, int):

return mol

else:

mols = [ ]
for snapshot in snapshots:

mols.append(mol)

return mols

def distance(self, ref, conf, select=None, metrics=‘crmsd’, *args, **kwargs):

r = ref.get_positions( )
c = conf.get_positions( )
d = rmsd(r,c,*args, **kwargs)
return d

def distance_matrix(self, start=None, end=None, select=None, metrics=‘crmsd’):

if start is None:

start = 0

if end is None:

end = self.count

if select is None:

select = self.select_{—}

dist = numpy.zeros((end-start, end-start), dtype=numpy.float)
for i in range(start, end):

for j in range(i+1, end):

s = self.distance(self[i], self[j], select, metrics)
dist[i][j] = s
dist[j][i] = s

return dist

def clustering(self, matrix, method=‘dbscan’, *args, **kwargs):

if method == ‘dbscan’:

model = DBSCAN(eps=0.3, min_samples=20).fit(matrix)

return model

One of skill in the art would understand that this code can be adapted to be used with other coding languages such as Java, Pearl and C++, to name a few. This script allows importation of MD snapshots for clustering by DBSCAN. When using DBSCAN for MD simulation snapshot clustering, a distance matrix of pair-wise snapshots is calculated and the pair-wise snapshots are clustering with the distance matrix. The RMSD distance is used to measure the difference between two snapshots using MDAnalysis (http://www.mdanalysis.org/). For all snapshots, pair-wise RMSD distances are calculated as a RMSD distance matrix. This matrix is used by DBSCAN clustering algorithms implemented in scikit-learn (http://scikit-learn.org/) for MD snapshot clustering.

In the methods provided herein, once snapshots obtained from one or more trajectories are clustered, a set of the snapshot clusters are identified from one or more trajectories as corresponding to conformations of the target protein, each conformation corresponding to a particular set of positions for the plurality of amino acids for each of the conformations and a determination is made as to whether one or more compounds bind to one or more conformations of the target protein. For example, snapshots are clustered into groups according to their conformational similarity and then selected representative snapshots from each group are selected for docking studies. The DBSCAN clustering method is an example of a method that can be used to cluster snapshots. This method can be used to select the snapshot closest to the average structure as a representative structure from each cluster. Any of the methods set forth herein can further comprise MD simulation of a complex formed between a protein conformation and a compound that binds the protein conformation.

As used herein, three-dimensional (3D) structure refers to the Cartesian coordinates corresponding to an atom's spatial relationship to other atoms in a macromolecule, for example a protein macromolecule. In the methods provided herein, an estimated three-dimensional (3D) structure can be determined by computer modeling, nuclear magnetic resonance (NMR), X-ray crystallography, electron microscopy, or homology modeling. Optionally, the X-ray crystal structure, NMR structure, homology model, molecular models, or generated structures disclosed herein are subjected to energy minimization (EM) prior to performing an MD simulation.

Many in-silico methods for structure prediction and modeling can be used in connection with the methods described herein, including, without limitation, comparative protein modeling methods (e.g., homology modeling methods such as those described in Marti-Renom et al. 2000. Annu Rev Biophys Biomol Struct 29: 291-325), protein threading modeling methods (such as those described in Bowie et al. 1991. Science 253: 164-170; Jones et al. 1992. Nature 358: 86-89), ab initio or de novo protein modeling methods (Simons et al. 1999. Genetics 37: 171-176; Baker 2000, Nature 405: 39-42; Wu et al. 2007. BMC Biol 5: 17), physics-based prediction (Duan and Kollman 1998, Science 282: 740-744; Oldziej et al. 2005, Proc Natl Acad Sci USA 102: 7547-7552); or any combination thereof. Comparative modeling methods can be performed using a number of modeling programs, including, but not limited to, Modeller (Fiser and Sali 2003, Methods Enzymol 374: 461-91) or Swiss-Model (Arnold et al. 2006, Bioinformatics 22: 195-201). Protein threading modeling methods can be performed using a number of modeling programs, including, but not limited to, HHsearch (Soding 2005, Bioinformatics 21: 951-960), Phyre (Kelley and Sternberg. 2009, Nature Protocols 4: 363-371), or Raptor (Xu et al. 2003, J Bioinform Comput Biol 1: 95-117). Ab initio or de novo protein modeling methods can be performed using a number of modeling programs including, but not limited to, Rosetta (Simons et al. 1999. Genetics 37: 171-176; Baker 2000, Nature 405: 39-42; Bradley et al. 2003, Proteins 53: 457-468; Rohl 2004, Methods in Enzymology 383: 66-93) and I-TASSER (Wu et al. 2007. BMC Biol 5: 17). Where in-silico modeling programs involve super-positioning of three dimensional structures of similar proteins, the proteins can be related, but not identical. Related proteins include polypeptide members of a particular gene family, polypeptides having topologically similar binding sites, or polypeptides having at least 10% sequence identity within a domain of interest. Other criteria that can be used to determine if a protein exhibits sufficient relatedness for super-positioning based molecular modeling include, but are not limited to, sequence homology, three-dimensional relatedness (e.g. similarity of molecular folds, or protein domains) as a function of similarity in the three dimensional configuration, order of secondary structures, or topological connections (Murzin et al., J. Mol. Biol. 247: 536-540, 1995). Databases useful for assessing similarities of three dimensional relatedness include, but are not limited to, the Structural Comparison of Proteins (SCOP) and PROSITE (http://expasy.hcuge.ch).

Methods of obtaining a 3D structure using homology modeling are provided herein. The methods comprise determining if a chemical probe binds to one or more proteins in a library of proteins, wherein each of the proteins in the library has one or more conformations; identifying a set(s) of one or more protein conformations to which the chemical probe binds; and using a homology model to obtain an estimated 3D structure of the target protein based on the 3D structure of the set(s) of protein conformations. The estimated 3D structure can be based on the 3D structure of one or more sets of protein conformations. The methods can optionally comprise selecting a chemical probe prior to determining if the chemical probe binds to one or more proteins. In the methods disclosed herein, a chemical probe can be, but is not limited to, a compound, a ligand, a small molecule, a chemical or a drug. These terms are used interchangeably throughout.

One or more chemical probes can be used in the methods provided herein. For example, high throughput screening can be used to test libraries of chemical probes for binding activity. High throughput screening allows one of skill in the art to quickly conduct chemical, genetic or pharmacological tests in order to identify compounds that are suitable for drug design and for understanding the interaction or role of a particular biochemical process. High throughput screening can be in silico, i.e, computer-based screening methods.

In the methods of obtaining a 3D structure using a homology model, determining if the chemical probe binds to a protein can comprise identifying one or more binding sites on the protein and determining if the chemical probe binds to the binding site based on a docking score.

In the methods set forth herein, binding sites or other three dimensional topological features can be transient or non-transient features of a target protein that arise as a result of biomolecular binding or as a result of modification of the target protein. These topological features can evolve depending on the conformation of the target protein. In certain aspects, the volume and shape of an evolved three dimensional topological feature can have significance to the design of a chemical probe capable of recognizing and binding to the evolved feature.

As used herein, an evolved three dimensional topological feature, for example a binding site, can be defined according to geometric descriptions of the depth, size, volume, and/or amino acid composition. In certain aspects, the evolved three dimensional topological feature can be nearly spherical or form a curved groove composed of several interconnected subpockets. For example, the evolved three dimensional topological feature can be a binding site or a catalytic site within a large and/or a deep cleft on the surface of a target protein. Non-limiting examples of evolved three dimensional topological features include, but are not limited to, grooves, hydrophobic pockets, cavities or clefts. The evolved three dimensional topological features can be within a target protein, on the surface of a target protein, or both within and on the surface of a target protein.

Several types of algorithms for detecting and measuring pockets on proteins exist in the art. These algorithms include, but are not limited to geometric algorithms, energy-based methods, and precedence based methods. Algorithms that use combinations of geometric, energy, and/or precedence based methods are also suitable for use with the methods described herein. Examples of methods for identifying and scoring three dimensional features suitable for use in connection with the methods described herein are available in Perot et al., Drug Discov Today. 2010 August; 15 (15-16):656-67.

Geometric algorithms can be used to assess pockets on proteins according to a variety of different methodologies. Some methods function by fitting spheres into solvent-accessible pockets, whereas other geometric algorithms function by determining the interaction energy of a probe and a distinct location on a target protein. Specific geometric based pocket algorithms suitable for use with the methods described herein include, but are not limited to LigSite (Huang, B. and Schroeder, M. (2006), BMC Struct. Biol. 6: 19), SURFNET-ConSurf (Glaser, F. et al. (2006) Proteins 62: 479-488), algorithms that identify pockets using the alpha-shape principles such as APROPOS (Peters, K. P. et al. (1996) J. Mol. Biol. 256: 201-213), algorithms that define binding regions with sphere-based methods such as Binding-Response (Peters, K. P. et al. (1996) J. Mol. Biol. 256: 201-213), algorithms that identify surface accessible pockets using the weighted-Delaunay triangulation and the alpha-shape principles such as CAST (Liang, J. et al. (1998) Protein Sci. 7: 1884-1897) and CASTp (Binkowski, T. A. et al. (2003) Nucleic Acids Res. 31: 3352-3355), algorithms that construct a three dimensional grid over a molecule such as CAVER (Petrek, M. et al. (2006) BMC Bioinformatics 7: 316), algorithms that cluster alpha-shape spheres, such as Fpocket (Le Guilloux, V. et al. (2009) BMC Bioinformatics 10: 168), algorithms that place probe spheres on the protein van der Walls surface such as GHECOM (Kawabata, T. and Go, N. (2007) Proteins 68: 516-529), algorithms that employ scanning along search vectors to define pockets such as LigSite (Hendlich, M. et al. (1997) J. Mol. Graph. Model. 15: 359-363), algorithms that identify pockets using Monte Carlo-based approaches such as McVol (Till, M. S. and Ullmann, G. (2009) J. Mol. Model. 16: 419-429), algorithms that fill cavities in a protein with a set of spheres such as PASS (Brady, G. P. and Stouten, P. F. (2000) J. Comput. Aided Mol. Des. 14: 383-401), algorithms that map protein surfaces with 3D grid and spherical probes such as POCKET (Levitt, D. G. and Banaszak, L. J. (1992) J. Mol. Graph. 10: 229-234), algorithms that divide cluster only the high-depth subspaces on a protein surface such as PocketDepth (Kalidas, Y. and Chandra, N. (2008) J. Struct. Biol. 161: 31-42), algorithms that identify clusters of grid points with a buriedness index such as PocketPicker (Weisel, M. et al. (2007) Chem. Cent. J. 1: 7), algorithms that identify empty spaces between the protein's molecular surface such as Screen (Nayal and Honig (2006) Proteins 63, 892-906), algorithms that identify the functional surface of the protein such as SplitPocket (Tseng, Y. Y. et al. (2009) Nucleic Acids Res. 37 (Web Server issue), W384-389; Tseng, Y. Y. and Li, W.-H. (2009) Proteins 76: 959-976), algorithms that fit spheres into solvent-accessible spaces such as SURFNET (Laskowski, R. A. (1995) J. Mol. Graph. 13, 323-330), algorithms that employ a coating a protein with a three dimensional grid such as TravelDepth (Coleman, R. G. and Sharp, K. A. (2006) J. Mol. Biol. 362: 441-458), algorithms that score grid points on a protein surface according to their degree of burial such as VICE (Tripathi and Kellogg (2010) Proteins 78: 825-842), algorithms that delineate cavities such as VOIDOO (Kleywegt and Jones (1994) Acta Crystallogr. D: Biol. Cryst. 50: 178-185), algorithms that apply geometric potentials for binding-site prediction such as the algorithm of Xie and Bourne (Xie and Bourne (2007) BMC Bioinformatics 8 (Suppl. 4), S9), or any combination thereof.

SCREEN (Surface Cavity REcognition and EvaluatioN), a geometry based method, is to estimate the average volume of a drug binding cavity in angstroms (Nayal and Honig, Proteins 63: 892-906). In the methods provided herein, a binding site can have a volume of at least about 50 A°, at least about 100 A°, at least about 150 A°, at least about 200 A°, at least about 300 A°, at least about 400 A°, at least about 500 A°, at least about 700 A°, at least about 900 A°, at least about 930 A°, at least about 1000 A°, at least about 1200 A°, at least about 1500 A°, at least about 2000 A°, or at least about 3000 A° as measured using SCREEN.

Energy based pocket prediction and detection methods are also suitable for use with the methods described herein. Energy based methods, which can incorporate physics into the process of pocket detection, include algorithms that calculate a Lennard-Jones potential over a grid of a protein such as Energy-based ICM-PocketFinder (An, J. et al. (2005) Mol. Cell. Proteomics 4, 752-761), algorithms that position probes at grid points along a protein surface to determine interaction energies such as Q-SiteFinder (Laurie and Jackson (2005) Bioinformatics 21: 1908-1916), algorithms that identify regions on a protein having favorable van der Waals interactions such as SITEHOUND (Ghersi and Sanchez (2009) Proteins 74: 417-424), algorithms that identify a contiguous envelope of a protein with the atoms having largest possible interaction energy with the protein such as AutoLigand (Harris, R. et al. (2008) Proteins 70: 1506-1517), algorithms that identify energetically favorable binding sites such as GRID (Goodford, P. J. (1985) J. Med. Chem. 28: 849-857), algorithms that coat a protein with a plurality of different kinds of probes such as Surflex-Protomol (Ruppert, J. et al. (1997) Protein Sci. 6: 524-533), algorithms that identify Binding sites via docking such as MEDock (Chang et al. (2005) Nucleic Acids Res. 33 (Web Server issue), W233-238), or any combination thereof.

PocketFinder (An, J. et al. (2005) Mol. Cell. Proteomics 4: 752-761), an energy-based approach also be used. A binding site identified according to the methods described herein can have a volume of at least about 50 A°, at least about 100 A°, at least about 150 A°, at least about 200 A°, at least about 300 A°, at least about 400 A.degree°, at least about 500 A°, at least about 610 A°, at least about 700 A°, at least about 900 A°, at least about 930 A°, at least about 1000 A°, at least about 1200 A°, at least about 1500 A°, or at least about 2000 A° as measured using PocketFinder.

Binding sites can also be identified by using precedence based algorithms that compare structure information in a target protein to database of known binding pockets. Several such methods are known in the art and are suitable for use with the methods described herein. These structure based methods generally operate by local comparison of cavity regions of a target protein to unrelated proteins. Algorithms that can be used to identify evolved three dimensional topological features by evaluating binding site similarities with other proteins include, but are not limited to, algorithms that assess the physico-chemical properties of amino acid residue around a cavity and identify similarities in a database such as CavBase (Schmitt, S. et al. (2002)J. Mol. Biol. 323: 387-406), algorithms that employ sequence and structural alignment between binding sites such as CPASS (Powers, R. et al. (2006) Proteins 65: 124-135), algorithms that identify local structure features of proteins that share a common biochemical function such as CSC (Milik, M. et al. (2003) Protein Eng. 16: 543-552), algorithms that use threading to identify ligand binding sites across groups of weakly homologous template structures such as FINDSITE (Brylinski and Skolnick (2008) Proc. Natl. Acad. Sci. U.S.A. 105: 129-134), algorithms that use graph-matching to find pairwise three dimensional similarities such as IsoCleft (Najmanovich, R. et al. (2008) Bioinformatics 24: i1054111), algorithms that recognize common spatial arrangements of physico-chemical properties in the binding sites with the application of geometric hashing such as MultiBind (Shulman-Peleg, A. et al. (2008) Nucleic Acids Res. 36 (Web Server issue), W260-264), algorithms that employ clique detection on binding sites transformed into graphs such as the algorithm of Park and Kim (Park, K. and Kim, D. (2008) Proteins 71: 960-971), algorithms that assess local similarities solvent-accessible surfaces such as PROSURFER (Minai, R. et al. (2008) Proteins 72: 367-381), algorithms that integrate a plurality of existing databases and programs for three dimensional functional annotation such as Query3d (Ausiello, G. et al. (2005) BMC Bioinformatics 6 (Suppl. 4), S5), algorithms that compare a target protein against the 3D structure of another protein in complex with a ligand such as the algorithm of Ramensky et al. (Ramensky, V. et al. (2007) Proteins 69: 349-357), algorithms that measure distances between protein cavities to define a cavity fingerprint such as SiteAlign (Schalon, C. et al. (2008) Proteins 71: 1755-1778), algorithms that use geometric matching to detect similar three-dimensional structure such as SiteBase (Brakoulias and Jackson (2004) Proteins 56: 250-260), algorithms that employ hashing and matching of triangles of centers of physico-chemical properties such as SiteEngine (Shulman-Peleg, A. et al. (2004) J. Mol. Biol. 339: 607-633), algorithms that structural domains from the CDD (Conserved Domain Database) that are in complex with small compounds such as SMID-BLAST (Snyder, K. A. et al. (2006) BMC Bioinformatics 7: 152), algorithms that compare triangles of chemical groups built from chemical groups of atoms such as SuMo (Jambon, M. et al. (2005) Bioinformatics 21: 3929-3930), algorithms that identify similarities between protein binding sites based and the chemical similarity of matching residues such as VA (McGready, A. et al. (2009) J. Mol. Model. 15: 489-498), algorithms that combine clique-detection and geometric hashing approaches such as the algorithm of Weskamp et al. (Weskamp, N. et al. (2007) IEEE/ACM Trans. Comput. Biol. Bioinform. 4: 310-320), algorithms that can be employed as a pipeline for comparative modeling of protein-ligand complexes such as @TOME-2 (Pons and Labesse (2009) Nucleic Acids Res. 37 (Web Server issue), W485-491), or any combination thereof.

It is understood that the evolved three dimensional topological features identified according to the methods described herein, for example, one or more binding sites on a target protein, can be scored with regard to small molecule or other specific optimization parameters. Non-limiting examples of scoring functions are described in Teramoto and Fukunishi (2008) J. Chem. Inf. Model. 48: 288-295; Feher, M. (2006) Drug Discov. Today 11, 421-428; and Seifert, M. H. et al. (2007) Curr. Opin. Drug Discov. Devel. 10: 298-307.

As set forth above, the methods provided herein comprise the step of using a docking algorithm to determine if the chemical probe binds to one or more binding sites on a target protein based on a docking score. Optionally, parallelized docking can be performed.

Various docking algorithms are well known to one of ordinary skill in the art. Examples of such algorithms that are readily available include: GLIDE (Friesner et al., 2004 Glide: A New Approach for Rapid, Accurate Docking and Scoring. 1. Method and Assessment of Docking Accuracy, J. Med. Chem. 47(7): 1739-49), GOLD (Jones et al., 1995, Molecular Recognition of Receptor Sites using a Genetic Algorithm with a Description of Desolvation, J. Mol. Biol., 245: 43), FRED (McGann et al., 2012, FRED and HYBRID Docking Performance on Standardized Datasets, Comp. Aid. Mol. Design, 26: 897-906), FlexX (Rarey et al., 1996, A Fast Flexible Docking Method using an Incremental Construction Algorithm, J. Mol. Biol., 261: 470), DOCK (Ewing et al., 1997, Critical Evaluation of Search Algorithms for Automated Molecular Docking and Database Screening, J. Comput. Chem., 18: 1175-1189), AutoDock (Morris et al., 2009, Autodock4 and AutoDockTools4: Automated Docking with Selective Receptor Flexibility, J. Computational Chemistry, 16: 2785-91), IFREDA (Cavasotto et al., 2004, Protein Flexibility in Ligand Docking and Virtual Screening to Protein Kinases, J. Mol. Biol., 337(1): 209-225), ICM (Abagyan et al., 1994, ICM—A New Method for Protein Modeling and Design: Application to Docking and Structure Prediction from the Distorted Native Conformation,” J. Comput. Chem., 15: 488-506), and AutoDock Vina (Trott et al. “AutoDock Vina: improving the speed and accuracy of docking with a new scoring function, efficient optimization and multithreading,” J. Comput. Chem. 31:455-461 (2010)), among others.

In the step of obtaining an estimated 3D structure of a target protein, the 3D structure can be further based on a sequence similarity score between the target protein sequence and the sequence of one or more protein conformations, the chemical structure of the chemical probe, the structure of one or more binding sites to which the chemical probe binds and the crystal structure of a protein that has global or local sequence similarity with one or more protein conformations.

The methods provided herein can further comprise determining one or more preferred binding conformations for the target protein. A preferred binding conformation refers to an energetically preferred orientation of a chemical probe to a target when bound or docked to each other to form a stable chemical probe-target complex. Optionally, a preferred binding conformation can be optimized to obtain an optimized preferred binding conformation. An optimized preferred binding conformation refers to the energetically preferred orientation of a chemical probe to a target when bound or docked to each other to form a stable chemical probe-target complex, following optimizing the preferred binding conformations using MD simulation.

Any of the methods set forth herein can further comprise determining the efficacy of the chemical probe in an in vitro biological assay or in vivo in a subject, (e.g., a wild type animal or a transgenic animal model). The methods disclosed herein can also include validating or confirming in silico predicted activities of the chemical probe, for example, in silico binding of the chemical probe to conformation of the target protein, with the results of an in vitro biological assay, or with the results of an in vivo study in an animal model.

Any of the methods set forth herein can further comprise determining the toxicity of the chemical probe in an in vitro, in vivo or in silico assay. As used herein, toxicity refers to a harmful effect on a cell or organism. For example, and not to be limiting, the cardiotoxicity or neurotoxicity of a compound can be determined. In vitro methods for assessing cardiotoxicity are known in the art. For example, electrophysiology measurements can be performed in cells, including, for example single cardiac cells. The effect of one or more compounds can be assessed in cell lines that express the human ether-a-go-go related gene (hERG1) or in cells tranfected with hERG1. The hERG safety assay from Cyprotex (Watertown, Mass.) can also be used. Cardiotoxicity can also be measured in vivo by conducting an electrocardiogram (ECG) in a subject (e.g., a wild type animal or transgenic animal) expressing hERG1 after administering the compound to the animal. In vitro cytotoxicity panels can also be used to measure toxicity in individual cells. For example, assays that measure nuclear size, mitochondrial membrane potential, intracellular calcium, membrane permeability and/or cell number can be used. See, for example, the ADME-Tox panel available from EuroFins PanLabs, Inc. (Redmond, Wash.). In this assay, all five parameters are measured. Intracellular calcium and membrane permeability will increase in the presence of a cytotoxic compound. Conversely, nuclear size, cell number and mitochondrial membrane potential will decrease in the presence of a cytotoxic compound.

Genotoxicity studies can also be performed to identify mutagenic compounds. Gene mutations can be detected in bacteria, where they cause a change in growth requirements. The Ames test, which is conducted using Salmonella typhimurium is a widely used bacterial assay for the identification of compounds that can produce gene mutations, and it shows high predictive value with rodent carcinogenicity tests. Micronucleus assays can also be used to identify mutagenic compounds. Micronucleus formation is a hallmark of genotoxicity. Micronuclei are chromatin-containing bodies that represent fragments or even whole chromosomes that were not incorporated into a daughter cell nucleus at mitosis. The purpose of the assay is to detect those agents that induce chromosome damage leading to the induction of micronuclei in interphase cells. Assays that measure Cytochrome p450 (CYP) inhibition, CYP induction or drug transporter inhibition can also be performed.

Any of the methods provided herein can further comprise determining if the chemical probe has an adverse drug reaction (ADR) or off-target effect in an in vitro, in vivo or in silico assay. It should be noted that off-target effects may be desirable or undesirable effects. In silico methods for determining off-target effects are known in the art. See, for example, LaBute et al. Adverse Drug Reaction Prediction Using Scores Produced by Large-Scale Drug-Protein Target Docking on High-Performance Computing Machines, PloS One 9(9): e106298 (2014); Wang et al. TargetHunter: An In Silico Target Identification Tool for Predicting Therapeutic Potential of Small Organic Molecules Based on Chemogenic Database, The AAPS Journal 15(2): 395-406 (2013); and Keiser, M. J. (2015) In Silico Prediction of Drug Side Effects, in Antitargets and Drug Safety (eds L. Urbán, V. F. Patel and R. J. Vaz), Wiley-VCH Verlag GmbH & Co. KGaA, Weinheim, Germany.

In vitro assays for assessing off-target effects are also known in the art. See, Bowes et al. Reducing safety-related drug attrition: The use of in vitro pharmacological profiling, Nature Review Drug Discovery 11:909 (2012) for a review of in vitro assays that can identify undesirable off-target activity. Any of the chemical probes can be tested in in vitro assays that assess the effect of the chemical probe on one or more the following targets: adenosine receptor A_{2A}, α_{1A}-adrenergic receptor, α_{2A}-adrenergic receptor, β₁-adrenergic receptor, β₂-adrenergic receptor, cannabinoid receptor C_{B1}, cannabinoid receptor C_{B2}, cholecystokinin A receptor, dopamine receptor D₁, dopamine receptor D₂, endothelin receptor A, histamine H₁ receptor, histamine H₂ receptor, delta-type opioid receptor, kappa-type opioid receptor, mu-type opioid receptor, muscarinic acetylcholine receptor M₁, muscarinic acetylcholine receptor M₂, muscarinic acetylcholine receptor M₃, 5-HT_{1A}, 5-HT_{1B}, 5-HT_{2A}, 5-HT_{2B}, vasopressin V_{1A} receptor, acetylcholine receptor subunit α1 or α4, voltage-gated calcium channel subunit α Cav1.2, GABA_{A} receptor α1 BZD site, potassium voltage-gated channel subfamily H member 2; hERG; potassium voltage-gated channel KQT-like member 1 and minimal potassium channel MinK, NMDA receptor subunit NR1, 5-HT₃, voltage-gated sodium channel subunit α Nav1.5, acetylcholinesterase, cyclooxygenase 1, cyclooxygenase 2, monoamine oxidase A, phosphodiesterase 3A, phosphodiesterase 4D, lymphocyte-specific protein tyrosine kinase, dopamine transporter, noradrenaline transporter, serotonin transporter, androgen receptor or glucocorticoid receptor.

Any of the methods provided herein can further comprise optimizing the chemical probe. A chemical probe can be modified or optimized for certain properties. For example, a chemical probe can be modified to reduce toxicity of the chemical probe, to reduce an undesirable off-target effect, to increase the binding affinity of the a chemical probe to a target protein, to decrease the binding affinity of the a chemical probe to a target protein, to increase an activity of a desirable off-target protein or to decrease an activity of an off-target protein.

### In Silico Identification of Compounds

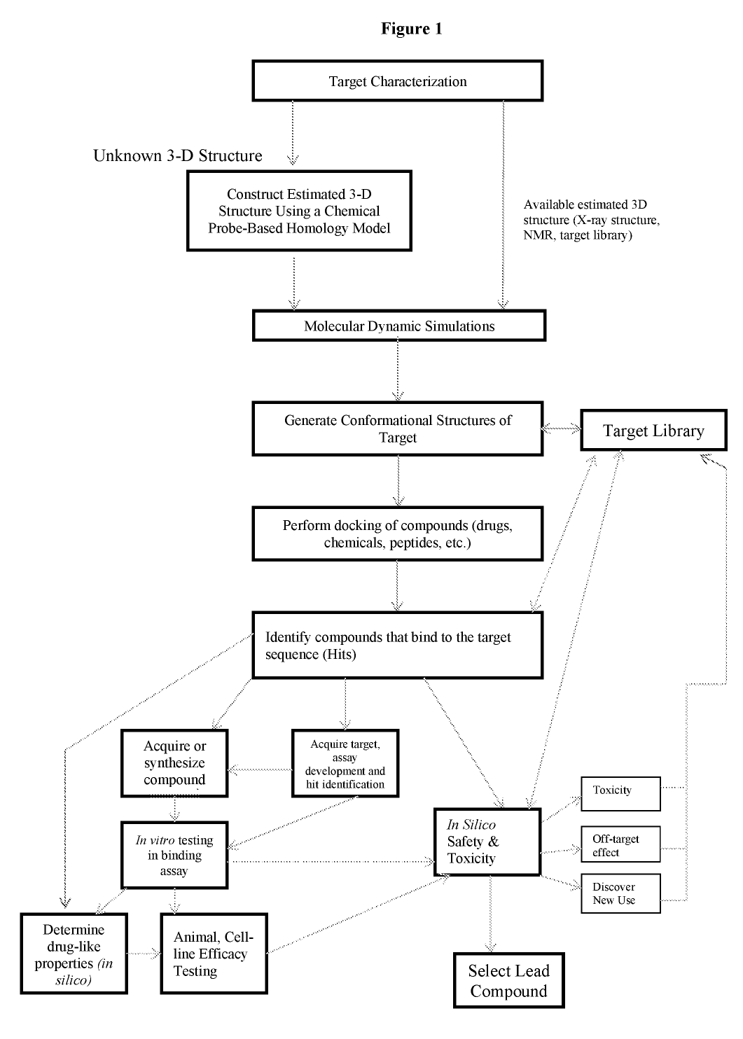

FIG. 1 provides a system diagram for identifying a compound that binds a target protein. Processes illustrated in the system include target characterization, which includes homology modeling of a target protein with an unknown structure, generation of protein conformations using molecular dynamics simulations (MD or MD simulation) and clustering, docking, identification of compounds that bind to the target protein, experimental testing, safety testing and toxicity testing. Many of the processes in the system, including homology modeling, MD simulations, clustering and docking can be performed in silico, for example, on a computer or a supercomputer.

One of skill in the art can use a grid computing environment for selecting a compound that binds a target protein. A user can use a computer to interact with the grid computing environment in a number of ways, such as over one or more networks. The grid computing environment can assist users in selecting a compound that binds a target protein.

One or more data stores can store the data to be analyzed by the grid computing environment as well as any intermediate or final data generated by the grid computing environment. Optionally, the configuration of the grid computing environment allows its operations to be performed such that intermediate and final data results can be stored solely in volatile memory (e.g., RAM), without a requirement that intermediate or final data results be stored to non-volatile types of memory (e.g., disk).

For example, the grid computing environment can receive structural information describing the structure of the target protein, and perform a molecular dynamics simulation of the protein structure. Then, the grid computing environment uses a clustering algorithm to identify conformations of the protein structure from the molecular dynamics simulation, and selects the conformations of the protein structure identified from the clustering algorithm. In addition, the grid computing environment can receive structural information describing conformers of one or more chemical probes, and use a docking algorithm to dock the conformers of the one or more chemical probes to the conformations. The grid computing environment can further identify a plurality of preferred binding conformations for each of the combinations of protein and compound, and optimize the preferred binding conformations using molecular dynamics simulations so as to determine whether the compound binds to the target protein in the preferred binding conformations.

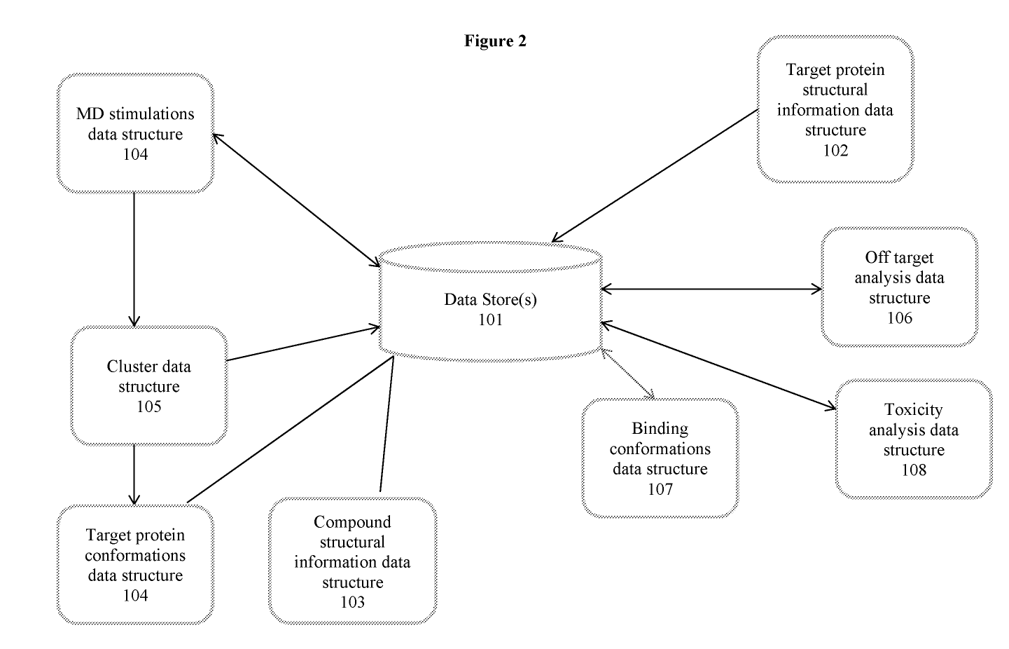

FIG. 2 depicts examples of data structures that are used to identify a compound that binds to a target protein. Multiple data structures are stored in a data store 101, including a target protein structural information data structure 102, a compound structural information data structure 103, a molecular-dynamics-simulations data structure 104, a cluster data structure 105, an off target analysis data structure 106, a binding conformation structure 107 and a toxicity analysis data structure 108. The data store 101 can be different types of storage devices and programming constructs (e.g., RAM, ROM, Flash memory, flat files, databases, programming data structures, programming variables, IF-THEN (or similar type) statement constructs, etc.). For example, the data store 101 can be a single relational database or can be databases residing on a server in a distributed network.

The target protein structural information data structure 102 is configured to store data related to the structure of the target protein, for example, special relationship data between different atoms. The data related to the structure of the target protein may be obtained from a homology model, an NMR solution structure, an X-ray crystal structure, a molecular model, etc. The target protein structural information data structure can also contain off target protein structural information. Optionally, the data store(s) can containg a separate off target protein structural data structure. Molecular dynamics simulations can be performed on data stored in the target protein structural information data structure 102. For example, the molecular dynamics simulations involve solving the equation of motion according to the laws of physics, e.g., the chemical bonds within proteins being allowed to flex, rotate, bend, or vibrate. Information about the time dependence and magnitude of fluctuations in both positions and velocities of the given molecule/atoms is obtained from the molecular dynamics simulations. For example, data related to coordinates and velocities of molecules/atoms at specified time intervals are obtained from the molecular dynamics simulations. Trajectory data (e.g., snapshots obtained at different time points) are formed based on the positions and velocities of molecules/atoms resulting from the molecular dynamics simulations and stored in the molecular-dynamics-simulations data structure 104. The molecular dynamics simulations can be of any duration.

Data stored in the molecular-dynamics-simulations data structure 104 are processed using a clustering algorithm, and associated cluster data are stored in the cluster data structure 105. Cluster data structure can include snapshot clusters corresponding to conformations of the target protein.

Data stored in the compound structural information data structure 103 can be processed together with data related to the conformations of the target protein stored in the conformations data structure 104. One or more chemical probes are docked to the conformations of the structure of the target protein using a docking algorithm, for example, AutoDock Vina, so that data related to various combinations of target protein and chemical probe are determined and stored in the binding-conformations data structure 107. As an example, the binding-conformations data structure includes data related to binding energies that can be used to select preferred binding conformations. 2D information of the chemical probe may be translated into a 3D representative structure to be stored in the compound structural information data structure 103 for docking.

The identified preferred binding conformations are optimized using molecular dynamics simulations. Optionally, binding energies are calculated for each of the combinations of protein and chemical probe in the corresponding optimized preferred binding conformation(s).

A given compound or probe can be docked against multiple targets using the data in the target protein structural information data structure 102 to determine off target or toxic effects. Data from off target and toxic effects analysis can be stored in an off-target analysis data structure 106 and a toxicity analysis data structure 108, respectively.

A system can be configured such that a system for identifying a compound that binds to a target protein can be a stand-alone computer for access by a user. Additionally, the methods and systems described herein may be implemented on many different types of processing devices. The software program instructions can include source code, object code, machine code, or any other stored data that is operable to cause a processing system to perform the methods described herein. Firmware or designed hardware configured to carry out the methods and systems described herein can also be employed.

The systems' and methods' data (e.g., associations, mappings, data input, data output, intermediate data results, final data results, etc.) can be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods can be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include clients and servers. A client and server are generally remote from each other and typically interact through a communication network. The relationship of client and server arises by virtue of computer programs running on the respective computers and having a client-server relationship to each other.

Disclosed are materials, compositions, and components that can be used for, can be used in conjunction with, can be used in preparation for, or are products of the disclosed methods and compositions. These and other materials are disclosed herein, and it is understood that when combinations, subsets, interactions, groups, etc. of these materials are disclosed that while specific reference of each various individual and collective combinations and permutations may not be explicitly disclosed, each is specifically contemplated and described herein. For example, if a method is disclosed and discussed and a number of modifications that can be made to a step(s) in the method are discussed, each and every combination and permutation of the method, and the modifications that are possible are specifically contemplated unless specifically indicated to the contrary. Likewise, any subset or combination of these is also specifically contemplated and disclosed. This concept applies to all aspects of this disclosure including, but not limited to, steps in methods. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

Publications cited herein and the material for which they are cited are hereby specifically incorporated by reference in their entireties.

The following examples are put forth so as to provide those of ordinary skill in the art with a complete disclosure and description of how the compounds and/or methods claimed herein are made and evaluated, and are intended to be purely exemplary of the invention and are not intended to limit the scope of what the inventors regard as their invention except as and to the extent that they are included in the accompanying claims.

### Examples

### Homology Modeling

Homology modeling of leucine rich receptor kinase 2 (LRRK2) employed the MODELLER 9.11 tool. The sequence alignment of target and template used Clustal Omega available at UniProt. Template selection is a critical step for a successful homology (comparative) modeling, because it is one of the main sources of errors in model quality. As a general rule, models built with 50% sequence identity or more are accurate enough for drug discovery applications. However, there is no template structure available in the PDB database meeting this requirement, with the best having around 34% sequence identity. Thus, a chemical probe guided strategy was employed that takes into account both sequence identity and the binding ligand between target sequence and template structure Traditional homology modeling is based on the global similarity of the template and target protein. The chemical probe guided approach takes local similarity with respect to ligand binding between the template and the target protein into consideration. Studies showed that a ligand, PDLK002, interacts with with nine kinases other than LRRK2, including AURKA, DCAMKL1, DCAMKL2, ERK5, MKNK2, PIK3CG, PLK4, TNK1 and TNK2. To identify the kinase candidates, KINOMEscan was used to measure the binding affinity of individual kinase proteins. The sequence identities of these nine kinases to LRRK2 (the kinase domains defined by Pfam) are from 24% to 29%, except PIK3CG (14% sequence identity) which was discarded for further homology modeling. Among the remaining eight kinases, five of them had PDB structures available with a resolution better than 2.5 angstroms, and were considered as potential templates in homology modeling for LRRK2. If more than one PDB structure was available, the holo structure (bound with ligand) with the best resolution was selected. Five template structures were obtained. For each template structure, ten homology models were built and the model with highest DOPE score was selected as the best model for the specific template. After performing homology modeling as set forth above, five homology models were obtained for LRRK2.

### Chemical Probe Selection and Preparation

NCI Diversity Set V in SDF format was obtained from the Developmental Therapeutics Program website. OpenBabel, was used to generate 3-dimensional coordinates from 2-dimensional coordinates for all chemicals. The largest contiguous fragment was retained if more than one fragment was available in the molecule. To prepare a PDBQT file required for docking with Autodock Vina, the script of prepare_ligand4.py script from MGLTools was employed.

### Molecular Dynamics Simulation

A GROMACS package (version 4.5) was used for all molecular simulation experiments. Protein structures and small-molecule ligands (if available) were cleaned and topology files were subsequently generated by using the CHARMM27 force field and SwissParam server, respectively. Then, the structures were put in a cubic box with a margin of 1.0 nm to all box edges, and solvated using the explicit TIP3P water model. The net charge of the system was neutralized by adding counter ions, Na⁺ and Cl⁻ Energy minimization of the system was done for 50,000 steps with a convergence criterion of 1000 kJ/mol/nm by the steepest descent algorithm. Before conducting the following two-phase equilibrations, NVT (Number of atom, Volume and Temperature are conserved) and NPT (Number of atoms, Pressure and Temperature are fixed), force constant of 1000 kJ/mol/nm and two temperature coupling groups (protein and ligand, water and ions) were created. Then, both the NVT (300 K) and NPT (1 atm) equilibrations were subsequently carried out for a 100 ps simulation. The production phase was run at a supercomputer using the MPI version of GROMACS. For all simulations, electrostatic interactions were calculated at every step with the particle-mesh Ewald method; Short-range repulsive and attractive dispersion interaction were simultaneously described by a Lennard-Jones potential with a cutoff at 1.0 nm. The SETTLE algorithm was used to constrain bonds and angles of water molecules and LINCS were used for all other bonds. The integration time step was set at 2 fs. The temperature was kept constant at 300 K by weakly coupling the system to an external heat bath (time constant 0.1 ps) and the pressure was kept constant at 1 atm by weak isotropic coupling to a pressure bath (1 ps). In addition, other tools such as VMD, PyMol and UCSF Chimera were used for visualization and analysis.

### Clustering

MD simulations generated a large number of snapshots of LRRK2 homology models to represent receptor flexibility. Five-hundred distinct conformational snapshots were identified. Snapshots were clustered into groups according to their conformational similarity and then selected representative snapshots from each group were selected for docking studies. More specifically, protein snapshots were obtained from a GROMACS MD trajectory file. The protein snapshots were read using the MDAnalysis Universe function. The MDAnalysis tool was used to extract snapshots and the rms library in the MDAnalysis package was used to calculate pairwise RMSD (Root Mean Square Deviation) distance between each snapshot to generate a RMSD matrix for snapshot clustering. The DBSCAN clustering method was employed from scikit-learn to cluster the snapshots using the RMSD matrix. All snapshots were then clustered into different clusters based on their RMSD distances. From each cluster, the snapshot closest to the average structure was selected as the representative structure to be used for further docking analysis.

### Docking

FPocket was used to identify potential druggable binding pockets from a given protein structure or multiple structures from a molecular dynamics simulation trajectory. The AutoDock Vina and AutoDockTools were used for molecular docking and molecular preparations. As docking a large chemical library against many snapshots is computationally intensive, a supercomputer and parallelized version of Autodock Vina were used in the calculation. AutoDock Vina is parallelized using MPI (Message Passing Interface) to make it allow the use of multiple processors on a supercomputer.

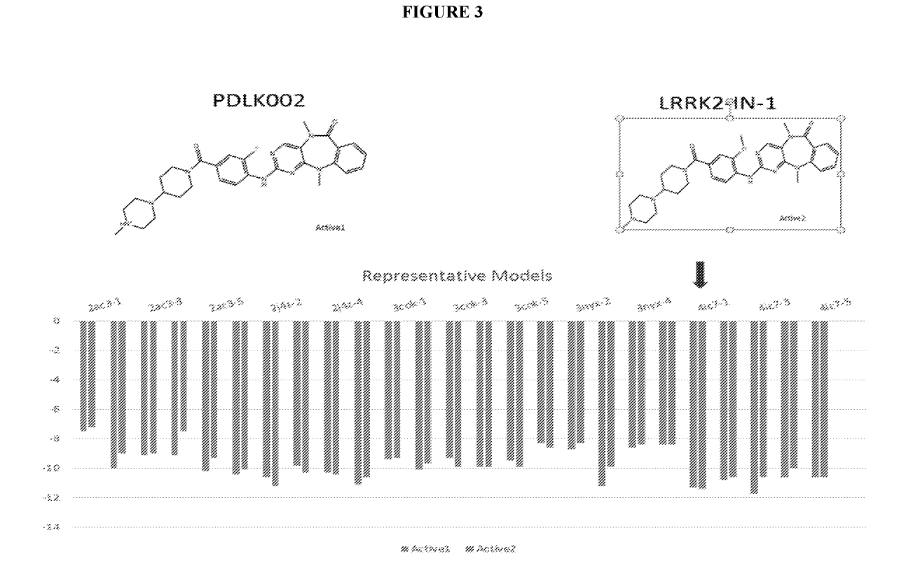

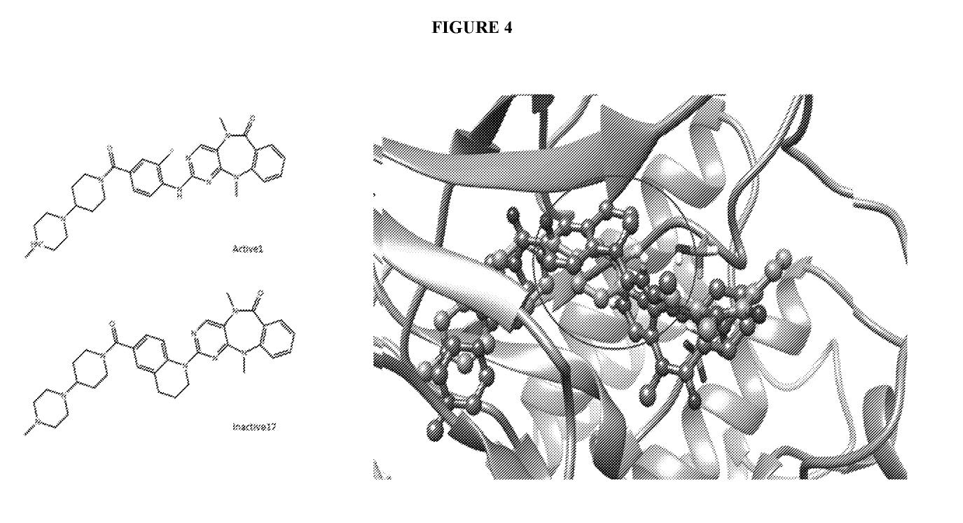

The receptor binding site is defined as a cubic box and placed at the center of the binding pocket. For all cases, the box is large enough to guarantee independence of the docking results from binding site definitions. The docking parameters are kept to their default values. For each snapshot from MD simulations, the top nine best ligand poses as well as receptor conformations were saved for further analysis. The docking score of Autodock Vina is employed to measure the interactions between chemical ligand and the receptor. As shown in FIG. 3, active compounds, PDLK002 and LRRK2-IN-1, were docked against representative homology models for LRRK2. FIG. 4 shows docking results against selected homology models for an active vs. an inactive compound.

### Scoring of Hits

The Autodock Vina docking score was employed to measure each interaction between a chemical ligand and the receptor. According to the docking scores, chemical compounds were ranked. The best hits were selected and manually inspected for additional biological experiments. The docking score assignment is based on the binding energy between a ligand and a protein target provided by AutoDock Vina. The smaller the docking score, the better the binding affinity, for example, a binding energy of −12 is indicative of better binding affinity as compared to a binding energy of −10.

### Off-Target Testing

The strategies of homology modeling, molecular dynamics simulations, molecular docking and scoring, etc. described above can be applied to multiple protein targets for off-target predictions. The difference between drug screening and off-target predictions is that drug screening is aimed at trying to find one or multiple chemicals that can interact with a specific drug target, while off-target prediction is directed toward identifying one or several potential protein targets that a drug (candidate) can interact with. Therefore, a target database that contains multiple potential protein targets is required for off-target prediction. A database containing conformational ensembles of protein kinases, ATP-dependent non-kinases, and ATP-binding pocket like proteins was built using long-term molecular dynamics simulations for kinase off-target predictions. These ensembles represent flexible conformational space of protein targets on a timescale akin to dynamic changes of protein structures under physiological conditions. These structural ensembles are used to improve the detection of target-ligand interactions including off-target effects of drugs/drug candidates. A given drug or drug candidate can be docked against multiple protein targets (including multiple conformations) from the database. Docking scores against all protein targets are collected and ranked. The off-target proteins of a drug or drug candidate are identified based on the ranked list. Off-target prediction employs a similar strategy. The drug candidate was docked against several off-target candidate proteins, then these proteins will be ranked based on their docking scores. The protein candidate with a good docking score will be considered as a potential off-target for the drug. After off-target analysis, a drug or drug candidate can be modified to modify off target effects. For example, the drug can be modified to reduce an off target effect. The drug can also be modified to increase or decrease the binding affinity of the drug for an off target protein or to increase or decrease an activity of an off-target protein. After modification, the modified drug can be docked against multiple protein targets, as described above, to determine if the modification has altered one or more off target effects associated with the drug prior to modification.

1. An in silico method of identifying a compound that binds to a target protein, the method comprising:
(a) receiving an estimated three-dimensional (3D) structure of a target protein, the 3D structure comprising a plurality of amino acids;
(b) performing molecular dynamic simulations of the target protein to obtain a plurality of trajectories of the 3D structure, wherein each trajectory corresponds to a different set of positions for the plurality of amino acids;
(c) obtaining a plurality of snapshots from each trajectory;
(d) clustering the plurality of snapshots using DBSCAN, wherein clustering comprises:
for a plurality of pairs of snapshots:
(i) computing a similarity metric between the pair of snapshots, the similarity metric including differences in positions of the plurality of amino acids between the two snapshots;
(ii) clustering the snapshots using the similarity metrics to obtain a plurality of snapshot clusters;
(e) identifying a set of the snapshot clusters from one or more trajectories as corresponding to conformations of the target protein, each conformation corresponding to a particular set of positions for the plurality of amino acids; and
(f) determining, for each of the conformations, whether a compound binds to the conformation of the target protein.

2. The method of claim 1, wherein the estimated three-dimensional (3D) structure is obtained by:
(a) selecting a chemical probe
(b) determining if the chemical probe binds to one or more proteins in a library of proteins, wherein each of the proteins in the library has one or more conformations;
(c) identifying a set(s) of one or more protein conformations to which the chemical probe binds; and
(d) using a homology model to obtain an estimated 3D structure of the target protein based on the 3D structure of the set(s) of protein conformations.

3. The method of claim 2, wherein the estimated 3D structure is based on the 3D structure of one or more sets of protein conformations.

4. The method of claim 2, wherein determining if the chemical probe binds to a protein comprises identifying one or more binding sites on the protein and determining if the chemical probe binds to the binding site based on a docking score.

5. The method of claim 4, wherein the one or more binding sites are determined using FPocket.

6. The method of claim 4, wherein the docking score is calculated using AutoDock Vina.

7. The method of claim 6, wherein a parallelized version of AutoDock Vina is used to calculate the docking score.

8. The method of claim 2, wherein the estimated 3D structure of the target is further based on one or more of an amino acid sequence similarity score between the target protein sequence and the sequence of one or more protein conformations, the chemical structure of the chemical probe, the structure of one or more binding sites to which the chemical probe binds and the crystal structure of a protein that has global or local sequence similarity with one or more protein conformations.

9. The method of claim 1, wherein the estimated structure is determined by NMR, X-ray crystallography, electron microscopy or any combination thereof.

10. The method of claim 1, further comprising testing the compound or chemical probe in an in vitro or in vivo assay to determine its efficacy.

11. The method of claim 1, further comprising determining the toxicity of the compound or chemical probe.

12. The method of claim 1, further comprising determining if the compound or chemical probe has an off-target effect.

13. The method of claim 11, wherein toxicity or the off-target effect is determined in an in vitro, in vivo or in silico assay.

14. The method of claim 1, further comprising optimizing the compound or chemical probe.

15. The method of claim 14, wherein the compound or chemical probe is optimized to reduce toxicity of the compound.

16. The method of claim 15, wherein the compound or chemical probe is optimized to reduce an off-target effect.

17. The method of claim 15, wherein the compound or chemical probe is optimized to increase or decrease the binding affinity of the compound or chemical probe for a target protein.

18. The method of claim 15, wherein the chemical probe is optimized to increase or decrease an activity of an off-target protein.
